(19) United States
(12) Patent Application Publication
(10) Pub. No.: US 2025/0342554 A1
(43) Pub. Date: Nov. 6, 2025

(54) REPROJECTION FALLBACK TOPOLOGY

(71) Applicant: QUALCOMM Incorporated, San Diego, CA (US)

(72) Inventors: Cullum James BALDWIN, San Diego, CA (US); Wesley James HOLLAND, Encinitas, CA (US)

(21) Appl. No.: 18/653,872

(22) Filed: May 2, 2024

(51) Int. Cl. G06T 1/20

(52) U.S. Cl. CPC G06T 1/20

(57) ABSTRACT

This disclosure provides systems, devices, apparatus, and methods, including computer programs encoded on storage media, for applying reprojection fallback strategies, for example during an excess system load on a reprojection topology. A graphics processor may determine that a first reprojection process for a frame will not complete within a time period. The first reprojection process may be associated with a first set of characteristics. The graphics processor may perform, based on the determination, a second reprojection process for the frame. The second reprojection process may be associated with a second set of characteristics that is different than the first set of characteristics. The graphics processor may output an indication of the performed second reprojection process for the frame, for example by outputting the indication to a frame buffer, by transmitting the indication, or by storing the indication on a memory.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current graphics processors may not address efficiently using a graphics processor to perform reprojection on a frame. There is a need for improved graphics optimization techniques when a reprojection process cannot be completed in time to display the processed frame.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may have at least one memory and at least one processor coupled to at least one memory. Based at least in part on information stored in the at least one memory, the at least one processor, individually or in any combination, may be configured to determine that a first reprojection process for a frame will not complete within a time period. The first reprojection process may be associated with a first set of characteristics. The at least one processor, individually or in any combination, may be configured to perform, based on the determination, a second reprojection process for the frame. The second reprojection process may be associated with a second set of characteristics that is different than the first set of characteristics. The at least one processor, individually or in any combination, may be configured to output an indication of the performed second reprojection process for the frame, for example by outputting the indication to a frame buffer, by transmitting the indication, or by storing the indication on a memory.

In some aspects, the techniques described herein relate to a method of graphics processing, including: determining that a first reprojection process for a frame will not complete within a time period, where the first reprojection process is associated with a first set of characteristics; performing, based on the determination, a second reprojection process for the frame, where the second reprojection process is associated with a second set of characteristics that is different than the first set of characteristics; and outputting an indication of the performed second reprojection process for the frame.

In some aspects, the techniques described herein relate to a method, where the first set of characteristics includes a first composition process, where the second set of characteristics does not include the first composition process.

In some aspects, the techniques described herein relate to a method, where the second set of characteristics includes a second composition process different from the first composition process.

In some aspects, the techniques described herein relate to a method, where the first composition process includes a first composition of a set of layers, where the second composition process includes a second composition of a subset of the set of layers, where the subset of the set of layers has less layers than the set of layers.

In some aspects, the techniques described herein relate to a method, where the first set of characteristics includes at least one of: a frame rate; a resolution; or a composition of layers.

In some aspects, the techniques described herein relate to a method, where the second set of characteristics includes at least one of: a second frame rate lower than the frame rate; a second resolution lower than the resolution; or a second composition of layers having a second number of layers less than a first number of layers of the composition of layers.

In some aspects, the techniques described herein relate to a method, where the first set of characteristics includes a composition of layers, where the second set of characteristics does not include any composition of layers.

In some aspects, the techniques described herein relate to a method, further including: performing the first reprojection process for a second frame before performing the second reprojection process for the frame, where the second set of characteristics includes at least one of a planar-warp or a time-warp of the frame; and outputting a second indication of the performed first reprojection process for the second frame.

In some aspects, the techniques described herein relate to a method, further including: performing the first reprojection process for a third frame; and outputting a third indication of the performed first reprojection process for the third frame after outputting the indication of the performed second reprojection process for the frame.

In some aspects, the techniques described herein relate to a method, where performing the first reprojection process for the third frame includes: performing the first reprojection process for the third frame before completing the performance of the second reprojection process for the frame.

In some aspects, the techniques described herein relate to a method, where performing the first reprojection process includes reprojecting the second frame based on the first set of characteristics using a first set of hardware, where performing the second reprojection process includes reprojecting the frame based on the second set of characteristics using a second set of hardware different from the first set of hardware.

In some aspects, the techniques described herein relate to a method, where outputting the indication of the performed second reprojection process for the frame includes at least one of: outputting, to a frame buffer, the indication of the performed second reprojection process for the frame; transmitting the indication of the performed second reprojection process for the frame; or storing, on a memory, the indication of the performed second reprojection process for the frame.

In some aspects, the techniques described herein relate to a method, where performing the second reprojection process for the frame includes: performing the second reprojection process for the frame on a graphics processing unit (GPU).

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example of rendered and reprojected frames that may be generated for a display, in accordance with one or more techniques of this disclosure.

FIG. 3 illustrates an example of a late stage reprojection (LSR) topology, in accordance with one or more techniques of this disclosure.

FIG. 4A illustrates an example of a reprojection fallback system, in accordance with one or more techniques of this disclosure.

FIG. 4B illustrates an example of an alternative reprojection fallback system, in accordance with one or more techniques of this disclosure.

FIG. 5 is a flowchart of an example method of graphics processing in accordance with one or more techniques of this disclosure.

FIG. 6 is a flowchart of an example method of graphics processing in accordance with one or more techniques of this disclosure.

FIG. 7 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

The following description is directed to examples for the purposes of describing innovative aspects of this disclosure. However, a person having ordinary skill in the art may recognize that the teachings herein may be applied in a multitude of ways. Some or all of the described examples may be implemented in any device or system that is capable of processing graphics commands. Various aspects relate generally to reprojecting and/or composing frames for a graphics processing unit (GPU). Some aspects more specifically relate to applying reprojection fallback strategies during an excess system load (e.g., when a reprojection process for a frame will not complete in time to display the frame). For example, a graphics system may have limited dynamic random access memory (DRAM) bandwidth due to concurrent work (e.g., rendering, GPU workload, high-intensity periods of camera data acquisition), software control latencies (e.g., poorly optimized code, latencies when communicating with third-party applications), bottlenecking hardware execution, and/or power/thermal throttling. Such loads may affect the calculated projected time for a reprojection process to complete within a threshold period of time. Use of remotely-rendered framebuffers (e.g., frames processed by a reprojection topology on a separate system, or a third-party system), may also affect the time to render a frame. For example, use of a second reprojection process may conserve resources if a first reprojection process uses remote-rendered framebuffers having a high calculated latency value, or if a first reprojection process uses a large amount of bandwidth (e.g., WiFi, 5G bandwidth) and a system is configured to conserve use of that bandwidth with respect to transmission/reception of remote-rendered frames.

In some examples, a graphics processor (or graphics processor system) may determine that a first reprojection process for a frame will not complete within a time period. The first reprojection process may be associated with a first set of characteristics (e.g., a frame rate, a resolution, a composition of layers, etc.). The graphics processor system may perform, based on the determination, a second reprojection process for the frame. The second reprojection process may be associated with a second set of characteristics that is different than the first set of characteristics (e.g., a second frame rate lower than the frame rate, a second resolution lower than the resolution, a second composition of layers having a second number of layers less than a first number of layers of the composition of layers, etc.). The graphics processor system may output an indication of the performed second reprojection process for the frame, for example by outputting the indication to a frame buffer, by transmitting the indication, or by storing the indication on a memory. In one example, a frame buffer may be a portion of a memory or buffer (e.g., a random-access memory (RAM)) that contains a bitmap for a display. A frame buffer may also be a memory buffer that contains data representing all the pixels in a frame.

A graphics processor system may be implemented on a GPU or other purpose-built hardware, for example hardware that interfaces with the display of a head mounted unit (HMU). A purpose-built hardware may receive rendered frames from a remote unit, for example a mobile phone device, and may reproject the rendered frames to a display. A reprojection process may receive one or more previously rendered frames as an input to extrapolate a prediction of a future frame. Such reprojection processes may use data from sensors, for example motion data from an HMU, to reproject and/or warp (e.g., planar-warp, time-warp) a previous frame to a future frame. A reprojection process may be associated with a set of characteristics, or attributes, that define the reprojection process. The characteristics may include, for example, a target frame rate (e.g., 90 frames per second (FPS), 360 FPS), a target resolution (e.g., 2K, 4K, 8K), or a composition of layers (e.g., a composition of red, green, and blue (RGB) layers, a composition of foreground and background layers). A reprojection process may include a composition process, for example a reprojection process may include warping of each layer of a set of layers, and a combination of the composite layers.

Such a reprojection topology for a graphics processor system may provide a fallback strategy for when reprojection/composition cannot be completed on time (e.g., due to excess system load). The fallback strategies may include, for example, reducing the frames per second (FPS) of a combined reprojection/composition (e.g., from 360 FPS to 90 FPS), using a simple reprojection (e.g., simple planar-warp, simple time-warp at the same FPS or at a lower FPS), using a previous frame with a simple reprojection (e.g., if a next frame is late). Use of such fallback strategies may provide extra time to the reprojection topology to allow the graphics processor system to generate a following frame using a more complex reprojection.

Particular aspects of the subject matter described in this disclosure can be implemented to realize one or more of the following potential advantages. In some examples, by providing one or more fallback strategies for reprojecting a frame, the described techniques can be used to avoid fame-drops and visual stuttering when a standard, complex reprojection will not complete a frame in time (e.g., in a time that is less than a threshold, for example less than 4 ms). While complex reprojection may be used to support visual quality and higher-render latencies, such complex reprojections may not always finish rendering frames in time for adequate display. Increasing reprojection complexity may increase the error-rate of latent frame processing. Offering one or more fallback strategies for a graphics processor to adopt allows the system to provide frames to a display at a full frame rate using a simplified reprojection process with a well-defined time-performance.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

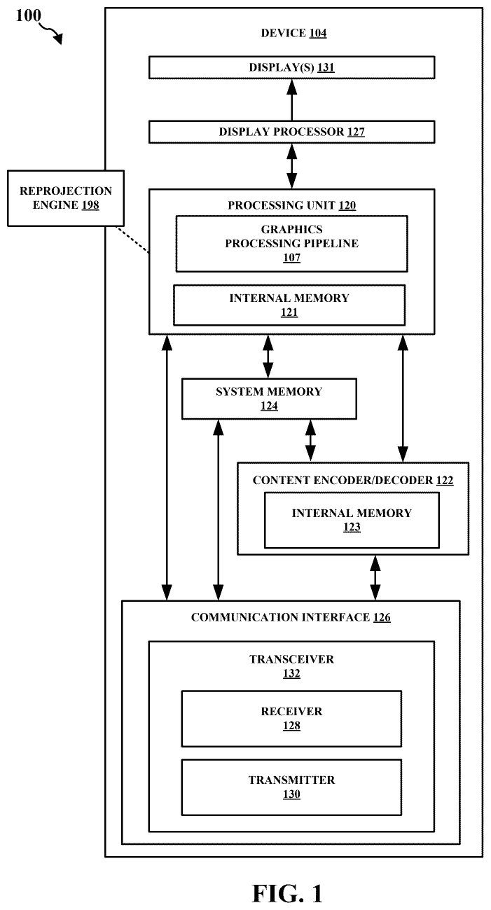

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a reprojection engine 198 configured to determine that a first reprojection process for a frame will not complete within a time period. The first reprojection process may be associated with a first set of characteristics. The reprojection engine 198 may perform, based on the determination, a second reprojection process for the frame. The second reprojection process may be associated with a second set of characteristics that is different than the first set of characteristics. The reprojection engine 198 may output an indication of the performed second reprojection process for the frame. For example, the reprojection engine 198 may output the indication to a frame buffer of the internal memory 123, may transmit the indication via the transmitter 130 or to the display processor 127, or may store the indication on a memory, for example the system memory 124. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

A purpose-built hardware for rendering graphics to a display, such as a GPU, may be configured to efficiently update a display-frame prior to display without performing a full re-render. For example, a graphics processor system may extrapolate, or reproject, a rendered frame to generate a predicted frame.

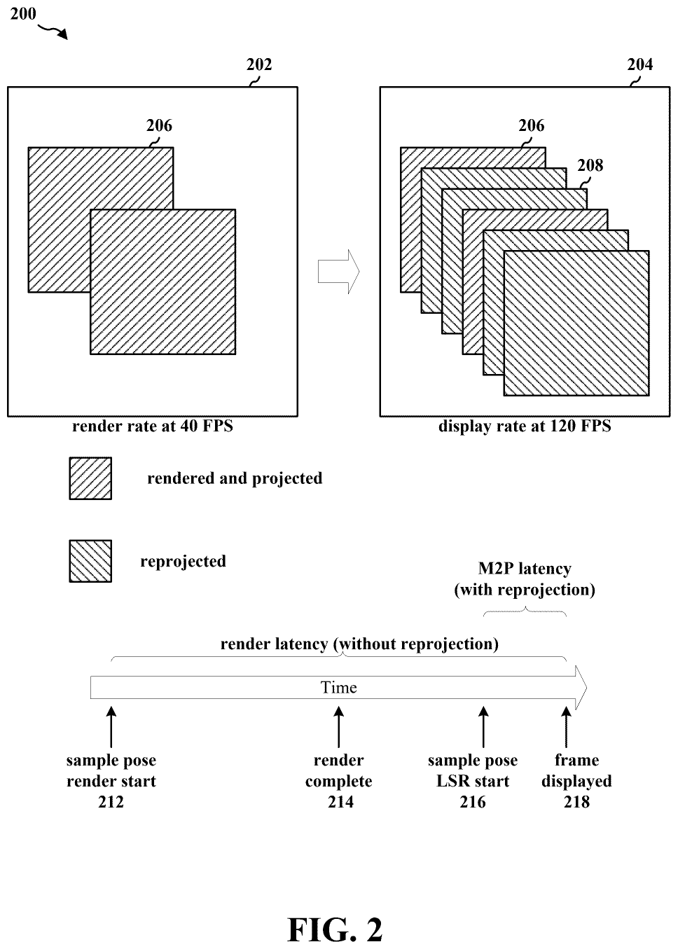

FIG. 2 is an illustration 200 of a set of frames 202 rendered at 40 frames per second (FPS) which have been used to reproject a set of frames 204 rendered at 120 FPS. The set of frames 202 may include frames which have each been rendered by a processor, for example a display processor, a GPU, or a remote device (e.g., a mobile device that transmits a rendered frame to a HMD). The set of frames 202 includes rendered frames 206 which have been rendered by a processing device.

In order to improve the visual quality (VQ) of what a user perceives in a display, a graphics processor system may decouple the render from the display update by reprojecting the rendered frames 206 to generate reprojected frames 208. Here, each of the rendered frames 206 which were rendered at 40 FPS may be reprojected twice more via a reprojection process to generate the reprojected frames 208 at 120 FPS. In other words, two additional reprojected frames of the reprojected frames 208 may be generated in between the rendered frames 206 that are adjacent to one another. By reprojecting the rendered frames 206, the graphics processor system may smooth perceived motion by up-sampling the frame rate of a video. Improved user perceived VQ may reduce the perceived motion to photon (M2P) latency which may be perceived at lower framerates, which may also be referred to as stuttering or chunky movement in a video. Such reprojection processing techniques may also be referred to as late state reprojection (LSR). While FIG. 2 illustrates a reprojection that increases the frame rate of a video, other reprojection techniques may be used to increase the resolution of a video, for example, by using high quality (HQ) lookup table filters to generate anti-aliased input, or to reproject multiple layers of a single frame individually before combining the composed layers.

When viewing rendered frames, such as the set of frames 202, the user perceived VQ may suffer without reprojecting the rendered frames. For example, the rendered frames 206 of the set of frames 202 may be rendered at 40 FPS. The motion to render to photon time (M2R2P) latency, which may be the time from when the system measures a new head pose of an HMD, performs the rendering of a frame, and then displays the frame on the screen, may be seen as chunky or stuttering movement by a user viewing a video generated using the rendered frames 206 of the set of frames 202. LSR algorithms and hardware may reduce the M2R2P latency. For example, a graphics processor system that does not use LSR algorithms may start rendering a frame at time 212 (e.g., measure the new head pose of an HMD), may complete rendering at 214, and then may display the rendered frames at time 218. In contrast, a graphics processor system that uses LSR algorithms may start rendering a frame at time 216, and may display the rendered frames at time 218. The more complex a rendered scene (e.g., additional layers, higher resolution, higher framerate), the longer the M2R2p latency may be. Reducing the latency for long M2R2P times may be achieved using complex algorithm and hardware.

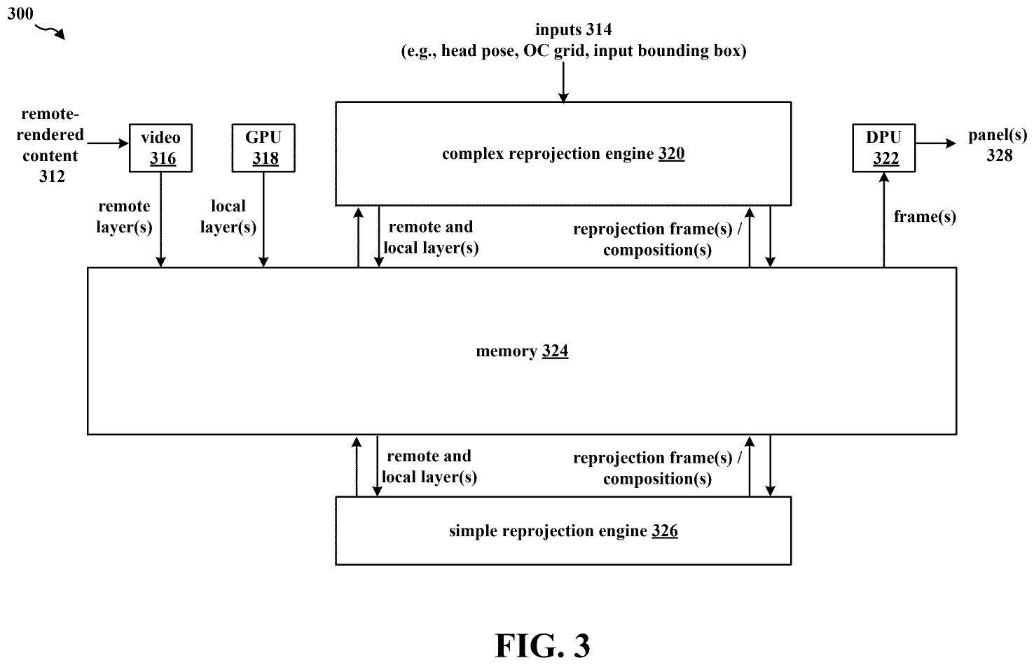

FIG. 3 is a diagram 300 of a graphics processor system having a complex and simple LSR topology. Such a topology may use a complex reprojection engine 320 and a simple reprojection engine 326. The graphics processor system illustrated in FIG. 3 may receive rendered content 312, for example a set of rendered frames from a remote device, via a video input interface 316. The video input interface 316 may save the rendered content 312 (e.g., a set of frames) to the memory 324, which may be a cache (for example, a last-level cache (LLC)). Each of the set of frames may be a composition of a set of layers, for example one frame may include three layers—one for each color—of an RGB frame or a luminance (Y) chrominance (UV) (YUV) frame. In some aspects, the complex reprojection engine 320 may process the frames of the rendered content 312 to generate layers that can be processed by the complex reprojection engine 320 (e.g., converting YUV layers into RGB layers or vice-versa).

The GPU 318 may generate a set of locally rendered layers, which may also be saved to the memory 324. The GPU 318 may generate the locally rendered layers based on a set of inputs 314 obtained by the complex reprojection engine 320, for example an updated head pose of a user of an HMD, an optical correction (OC) grid, and/or an input bounding box for the portion of the frame to be locally rendered by the GPU 318. The complex reprojection engine 320 may then reproject a set of reprojection frames based on the remote layers received via the video input interface 316 and generated by the GPU 318, which may then be output to a display processing unit (DPU) 322 for display to a set of panels 328. The complex reprojection engine 320 may use one of a variety of complex reprojection algorithms, for example by reprojecting each layer of a set of layers (e.g., RGB layers) independently, composing the images together, and applying lens distortion via the DPU 322 before outputting the video to the set of panels 328. While the complex reprojection engine 320 may improve the user perceived VQ of a video, use of the complex reprojection engine 320 may be time-consuming. In some aspects, the reprojection of a frame may not complete in time to be output to a display. This may result in an incomplete set of display-frames in a video, which may yield a frame-drop or may yield poor visual quality.

In some aspects, a graphics processor system may also have a simple reprojection engine 326, configured to perform a simple reprojection when the reprojection of a frame may not complete in time if the reprojection of the frame was to be performed by the complex reprojection engine 320. For example, the simple reprojection engine 326 may be configured to perform a planar-warp or a time-warp on a rendered frame to generate a reprojected frame.

While FIG. 3 illustrates a graphics processor system with one simple reprojection engine, a graphics processor system may include a plurality of simple reprojection engines, allowing for a single system to select from a plurality of reprojection fallback strategies if a complex reprojection is unable to generate a reprojected frame in time to display (e.g., a time less than a threshold). While FIG. 3 shows the complex reprojection engine 320 and the simple reprojection engine 326 as being two separate systems, or two separate sets of hardware, the complex reprojection engine 320 and the simple reprojection engine 326 may share systems, or may share hardware. For example, the simple reprojection engine 326 may include a subset of components of the complex reprojection engine 320 (e.g., the simple reprojection engine 326 may use a warping component of the complex reprojection engine 320 and not the composition component of the complex reprojection engine 320).

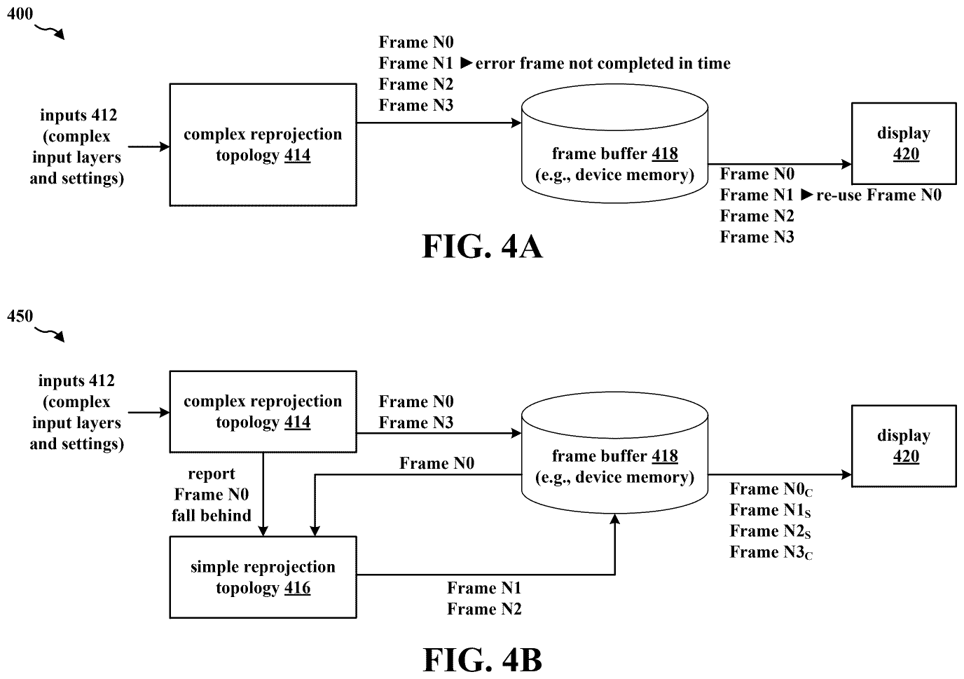

FIG. 4A is a diagram of a reprojection fallback system 400 that uses a complex reprojection topology 414 and not a simple reprojection topology. Such a system may receive a set of inputs 412, which may include, for example, a set of complex input layers (e.g., rendered layers from a remote device) and settings (e.g., updated head pose). The complex reprojection topology 414 may be configured to generate a set of reprojected frames, shown here as Frame N0, Frame N1, Frame N2, and Frame N3, based on the set of inputs 412. The complex reprojection topology 414 may or may not include a composition process as well as a reprojection process. The complex reprojection topology 414 may output the frames to the frame buffer 418, which may be a memory on a device accessible by a graphics processor system. The graphics processor system may be configured to output frames from the frame buffer 418 to the display 420 to maintain a configured FPS, e.g., 120 FPS.

The complex reprojection topology 414 may take longer to generate one frame than another frame. For example, the complex reprojection topology 414 may not complete generation of Frame N1 in time. In order to maintain the frame rate, the graphics processor system may send the Frame N0 instead of the Frame N1 to the display 420 to maintain the configured FPS. However, outputting two frames in a row may significantly impact the user perceived VQ, resulting in a user experiencing a visual stutter (i.e., a jank) or a chunky visual effect via the display 420. In some aspects, a graphics processor system may be configured to fallback to a hybrid reprojection process to provide frames via a different reprojection topology.

FIG. 4B is a diagram of a reprojection fallback system 450 that uses both a complex reprojection topology 414 and a simple reprojection topology 416 to generate reprojection frames. Such a system may receive a set of inputs 412, which may include, for example, a set of complex input layers (e.g., rendered layers from a remote device) and settings (e.g., updated head pose). Similar to FIG. 4A, the complex reprojection topology 414 may be configured to generate a set of reprojected frames, shown here as Frame N0, Frame N1, Frame N2, and Frame N3, based on the set of inputs 412. The complex reprojection topology 414 may or may not include a composition process as well as a reprojection process. The complex reprojection topology 414 may also output the frames to the frame buffer 418, which may be a memory on a device accessible by a graphics processor system. The graphics processor system may be configured to output frames from the frame buffer 418 to the display 420 to maintain a configured FPS, e.g., 120 FPS.

The complex reprojection topology 414 may take longer to generate one frame than another frame. For example, the complex reprojection topology 414 may not complete generation of Frame N1 in time. The complex reprojection topology 414 may be configured to determine whether a frame will be completed in time to be output in time to the frame buffer 418. For example, the complex reprojection topology 414 may be configured to estimate a time of completion for generating a reprojected frame based on attributes of the frame (e.g., a movement of an HMD pose from a previous pose to the current pose, an elapsed time for a benchmark first portion of the reprojected frame which may be extrapolated to calculate an estimated finishing time). In other aspects, the complex reprojection topology 414 may include a performance counter that indicates the number of pixels to be processed for a frame. A firmware, or software, component may be configured to estimate a projected completion timeline for a frame based on a rate of pixel processing (e.g., a current calculated rate, an average calculated rate, a calculated rate based on a type of reprojection) and the indicated number of pixels to be processed for the frame. The number of pixels to be processed may be received by the complex reprojection topology 414 via one of the set of inputs 412, and in response the complex reprojection topology may calculate whether the complex reprojection topology 414 will finish processing the number of pixels within a threshold time period (e.g., a calculated time threshold to transmit the processed frame to the frame buffer 418).

The complex reprojection topology 414 may estimate the projected completion timeline for the frame in other ways. In some aspects, the complex reprojection topology 414 may include the reception of a frame from a rendering entity. For example, the complex reprojection topology 414 may include a frame, or portion of a frame, rendered by a remote system that wirelessly transmits the processed frame, or portion of the frame, to another device in the complex reprojection topology 414. A delay processing a frame using the complex reprojection topology 414 may be caused by a delay in receiving a remote-rendered frame using the complex reprojection topology 414. In some aspects, the complex reprojection topology 414 may calculate the projected time to finish processing the frame based on a latency of obtaining a remote-rendered framebuffer. The complex reprojection topology 414 may obtain an estimate of when a remote-rendered framebuffer may be received by a device of the complex reprojection topology 414 based on an estimated bandwidth, an estimated throttling (e.g., reducing a bandwidth by a threshold amount due to a higher priority transmission that overlaps with the same time period as the remote-rendered framebuffer is scheduled to be received), a scheduled start/stop time for reception of the remote-rendered framebuffer, an estimated compression scheme, and/or an estimated modulation and coding scheme (MCS). In one aspect, the complex reprojection topology 414 may receive an MCS (e.g., associated with a scheduled transmission of the remote-rendered framebuffer), and correlate an attribute of the MCS with a projected completion time (e.g., a low MCS may be associated with a low bandwidth value in the lookup table and a relatively higher MCS may be associated with a relatively higher bandwidth value in the lookup table). The complex reprojection topology 414 may then calculate a projected completion time based on the bandwidth value provided by the lookup table.

In other words, the complex reprojection topology 414 may calculate that processing of a frame using the complex reprojection topology 414 may be delayed due to a complexity of the topology, and/or a delay in receiving a remote-rendered frame. In some aspects, the complex reprojection topology 414 may trigger a fallback strategy in response to determining that the complex reprojection topology 414 will not finish generating Frame N1 in time (e.g., later than a safety threshold time period). In response to determining that the complex reprojection topology 414 will not finish generating Frame N1 in time, the complex reprojection topology 414 may be configured to transmit a notification to the simple reprojection topology 416.

In response to receiving the notification that the complex reprojection topology 414 will not finish generating Frame N1 in time, the simple reprojection topology 416 may be configured to use Frame N0 generated by the complex reprojection topology 414 (or any other previously obtained frame) to generate Frame N1 and Frame N2. In some aspects, the simple reprojection topology 416 may request Frame N0 from the frame buffer 418 in response to receiving the notification that the complex reprojection topology 414 will not finish generating Frame N1 in time. In other aspects, the complex reprojection topology 416 may transmit the notification to the frame buffer 418, which then transmits Frame N0 to the simple reprojection topology 416. In other aspects, the frame buffer 418 may also receive the notification from the complex reprojection topology 414, and may output the last received frame from the complex reprojection topology 414 to the simple reprojection topology 416. The simple reprojection topology 416 may be any reprojection topology that is estimated to complete generation of a frame earlier than the complex reprojection topology 414. For example, the simple reprojection topology 416 may be configured to reduce the reprojection rate, or the composition rate, to allow for completing of generation of a frame within an established time period. In another example, the simple reprojection topology 416 may reduce a reprojection process from 360 FPS to 90 FPS. In another example, the simple reprojection topology 416 may apply a planar-warp to the Frame N0 to generate the Frame N1 and the Frame N2. In another example, the simple reprojection topology 416 may apply a time-warp to the Frame N0 to generate the Frame N1 and the Frame N2. In other words, the simple reprojection topology 416 may reuse Frame N0 to generate a visually acceptable Frame N1 and Frame N2 to avoid stuttering when the complex reprojection topology 414 will not finish generating Frame N1 in time. Additionally, the simple reprojection topology 416 may complete generation of a frame in a time that is less than a threshold time, whereas complex reprojection topology 414 may complete generation of a frame in a time that is greater than a threshold time.

Moreover, in response to receiving the notification that the complex reprojection topology 414 will not finish generating Frame N1 in time, the complex reprojection topology 414 may be configured to commence generating Frame N3 instead of continuing to generate Frame N1, thus preserving system resources. The complex reprojection topology 414 may continue to estimate whether the next frame will finish on time (e.g., Frame N4, Frame N5, Frame N6) and may again transmit a notification to the simple reprojection topology 416 if the complex reprojection topology 414 estimates that a frame will not be generated on time.

The frame buffer 418 may receive the Frame N1 and the Frame N2 from the simple reprojection topology 416, and the Frame N0 and the Frame N3 from the complex reprojection topology 414. The Frame N1 and the Frame N2 from the simple reprojection topology 416 may be referred to as the Frame N1_{S} and the Frame N2_{S}. The Frame N0 and the Frame N3 from the complex reprojection topology 414 may be referred to as the Frame N0_{C} and the Frame N3_{C}. The frame buffer 418 may output the Frame N0_{C}, the Frame N1_{S}, the Frame N2_{S}, and the Frame N3_{C} to the display 420 for output. Since the display 420 receives frames reprojected using two different reprojection topologies, the display 420 does not suffer from the same VQ impairments as the reprojection fallback system 400 in FIG. 4A.

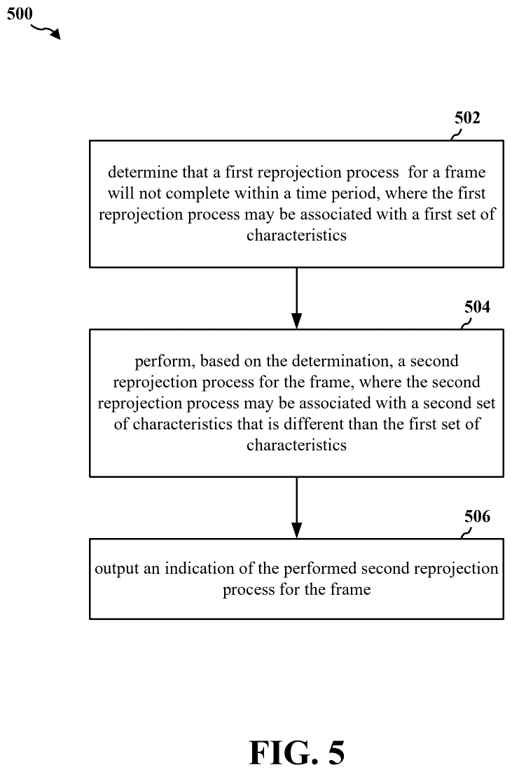

FIG. 5 is a flowchart 500 of an example method of graphics processing in accordance with one or more techniques of this disclosure. The method may be performed by an apparatus, such as an apparatus for graphics processing, a GPU, a CPU, a purpose-built hardware, or a wireless communication device, and the like, as used in connection with the aspects of FIGS. 1-4B.

At 502, the apparatus may determine that a first reprojection process for a frame will not complete within a time period, where the first reprojection process may be associated with a first set of characteristics. For example, 502 may be performed by the reprojection fallback system 450 in FIG. 4B, which may, using the complex reprojection topology 414, determine that the complex reprojection process of the complex reprojection topology 414 for the Frame N1 will not complete in time for the frame buffer 418 to timely output the Frame N1 to the display 420. The complex reprojection process of the complex reprojection topology 414 may be associated with a first set of characteristics, for example a composition of RGB layers, or a time-warp of each RGB layer independently from one another. In some aspects, a graphics system may have limited dynamic random access memory (DRAM) bandwidth due to concurrent work (e.g., rendering, GPU workload, high-intensity periods of camera data acquisition), software control latencies (e.g., poorly optimized code, latencies when communicating with third-party applications), bottlenecking hardware execution, bandwidth throttling (e.g., throttled bandwidth for receiving a remote-rendered frame), network latency, and/or power/thermal throttling. Such loads may affect the calculated projected time for a reprojection process to complete within a threshold period of time. In other aspects, a complex reprojection topology may use remote-rendered framebuffers which may increase the projected A system, such as the complex reprojection topology 414 in FIG. 4B or the reprojection engine 198 in FIG. 1, may be configured to calculate a projected time for a complex reprojection topology to complete reprojection of a frame. In response to the calculated projected time being greater or equal to a threshold value, the system component may determine that the complex reprojection process will not finish in time and may opt to process the frame using a simple reprojection topology, such as the simple reprojection topology 416 in FIG. 4B. Moreover, 502 may be performed by the reprojection engine 198 in FIG. 1.

At 504, the apparatus may perform, based on the determination, a second reprojection process for the frame, where the second reprojection process may be associated with a second set of characteristics that is different than the first set of characteristics. For example, 504 may be performed by the reprojection fallback system 450 in FIG. 4B, which may, using the simple reprojection topology 416, perform, based on the report received from the complex reprojection topology 414, a simple reprojection process of the simple reprojection topology 416 for the Frame N1. The simple reprojection process of the simple reprojection topology 416 may be associated with a second set of characteristics that is different than the first set of characteristics. For example, the simple reprojection process of the simple reprojection topology 416 may not include the composition of RGB layers, or may include the composition of just the RG layers and not the B layer. Moreover, 504 may be performed by the reprojection engine 198 in FIG. 1.

At 506, the apparatus may output an indication of the performed second reprojection process for the frame. For example, 506 may be performed by the reprojection fallback system 450 in FIG. 4B, which may, via the simple reprojection topology 416, output the reprojected Frame N1 and Frame N2 to the frame buffer 418. Moreover, the frame buffer 418 may output the Frame N1_{S} and the Frame N2_{S} to the display 420. Moreover, 506 may be performed by the reprojection engine 198 in FIG. 1.

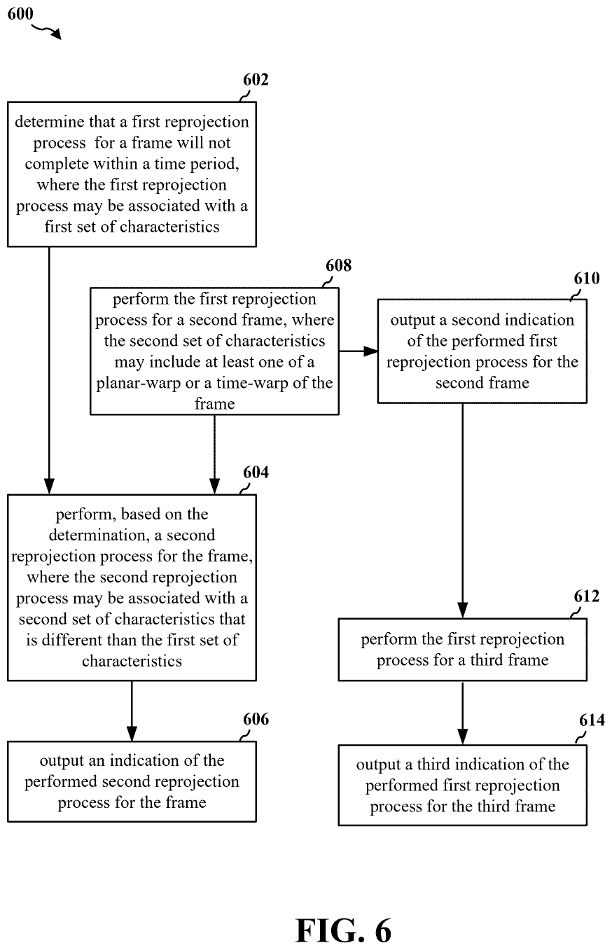

FIG. 6 is a flowchart 600 of an example method of graphics processing in accordance with one or more techniques of this disclosure. The method may be performed by an apparatus, such as an apparatus for graphics processing, a GPU, a CPU, a purpose-built hardware, or a wireless communication device, and the like, as used in connection with the aspects of FIGS. 1-4B.

At 602, the apparatus may determine that a first reprojection process for a frame will not complete within a time period, where the first reprojection process may be associated with a first set of characteristics. For example, 602 may be performed by the reprojection fallback system 450 in FIG. 4B, which may, using the complex reprojection topology 414, determine that the complex reprojection process of the complex reprojection topology 414 for the Frame N1 will not complete in time for the frame buffer 418 to timely output the Frame N1 to the display 420. The complex reprojection process of the complex reprojection topology 414 may be associated with a first set of characteristics, for example a composition of RGB layers, or a time-warp of each RGB layer independently from one another. Moreover, 602 may be performed by the reprojection engine 198 in FIG. 1.

At 604, the apparatus may perform, based on the determination, a second reprojection process for the frame, where the second reprojection process may be associated with a second set of characteristics that is different than the first set of characteristics. For example, 604 may be performed by the reprojection fallback system 450 in FIG. 4B, which may, using the simple reprojection topology 416, perform, based on the report received from the complex reprojection topology 414, a simple reprojection process of the simple reprojection topology 416 for the Frame N1. The simple reprojection process of the simple reprojection topology 416 may be associated with a second set of characteristics that is different than the first set of characteristics. For example, the simple reprojection process of the simple reprojection topology 416 may not include the composition of RGB layers, or may include the composition of just the RG layers and not the B layer. Moreover, 604 may be performed by the reprojection engine 198 in FIG. 1.

At 606, the apparatus may output an indication of the performed second reprojection process for the frame. For example, 606 may be performed by the reprojection fallback system 450 in FIG. 4B, which may, via the simple reprojection topology 416, output the reprojected Frame N1 and Frame N2 to the frame buffer 418. Moreover, the frame buffer 418 may output the Frame N1_{S} and the Frame N2_{S} to the display 420. Moreover, 606 may be performed by the reprojection engine 198 in FIG. 1.

At 608, the apparatus may perform the first reprojection process for a second frame. The second set of characteristics may include at least one of a planar-warp or a time-warp of the frame. For example, 608 may be performed by the reprojection fallback system 450 in FIG. 4B, which may perform the complex reprojection process of the complex reprojection topology 414 for the Frame N0 frame. The set of characteristics for the simple reprojection process of the simple reprojection topology 416 may include at least one of a planar-warp or a time-warp of the Frame N1. Moreover, 608 may be performed by the reprojection engine 198 in FIG. 1.

At 610, the apparatus may output a second indication of the performed first reprojection process for the second frame. For example, 610 may be performed by the reprojection fallback system 450 in FIG. 4B, which may, via the complex reprojection topology 414, output the generated N0 to the frame buffer 418. Moreover, 610 may be performed by the reprojection engine 198 in FIG. 1.

At 612, the apparatus may perform the first reprojection process for a third frame. For example, 612 may be performed by the reprojection fallback system 450 in FIG. 4B, which may perform the complex reprojection process of the complex reprojection topology 414 for the Frame N3. Moreover, 612 may be performed by the reprojection engine 198 in FIG. 1.

At 614, the apparatus may output a third indication of the performed first reprojection process for the third frame. For example, 614 may be performed by the reprojection fallback system 450 in FIG. 4B, which may, via the complex reprojection topology 414, output the Frame N3 to the frame buffer 418. Moreover, 614 may be performed by the reprojection engine 198 in FIG. 1.

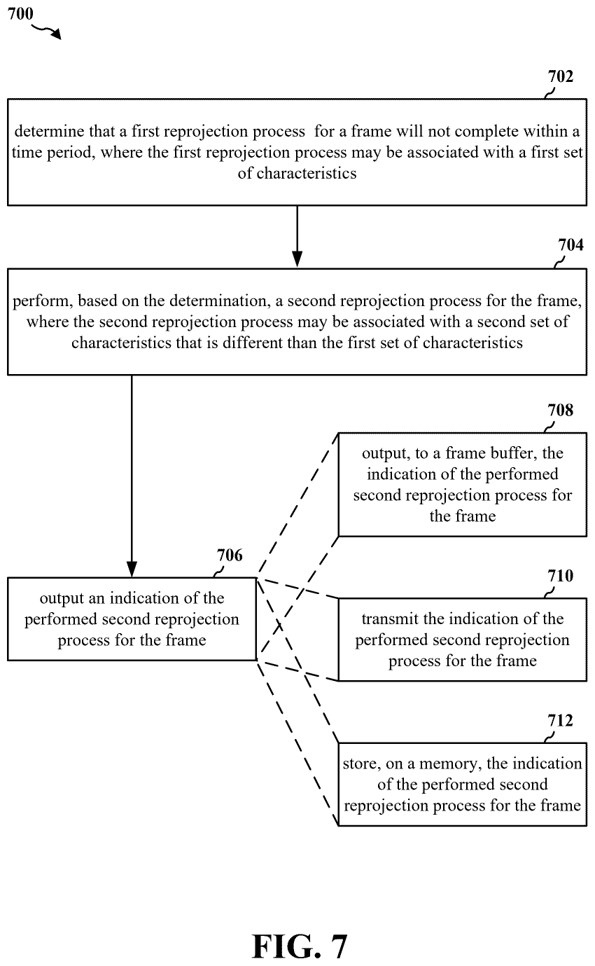

FIG. 7 is a flowchart 700 of an example method of graphics processing in accordance with one or more techniques of this disclosure. The method may be performed by an apparatus, such as an apparatus for graphics processing, a GPU, a CPU, a purpose-built hardware, or a wireless communication device, and the like, as used in connection with the aspects of FIGS. 1-4B.

At 702, the apparatus may determine that a first reprojection process for a frame will not complete within a time period, where the first reprojection process may be associated with a first set of characteristics. For example, 702 may be performed by the reprojection fallback system 450 in FIG. 4B, which may, using the complex reprojection topology 414, determine that the complex reprojection process of the complex reprojection topology 414 for the Frame N1 will not complete in time for the frame buffer 418 to timely output the Frame N1 to the display 420. The complex reprojection process of the complex reprojection topology 414 may be associated with a first set of characteristics, for example a composition of RGB layers, or a time-warp of each RGB layer independently from one another. Moreover, 702 may be performed by the reprojection engine 198 in FIG. 1.

At 704, the apparatus may perform, based on the determination, a second reprojection process for the frame, where the second reprojection process may be associated with a second set of characteristics that is different than the first set of characteristics. For example, 704 may be performed by the reprojection fallback system 450 in FIG. 4B, which may, using the simple reprojection topology 416, perform, based on the report received from the complex reprojection topology 414, a simple reprojection process of the simple reprojection topology 416 for the Frame N1. The simple reprojection process of the simple reprojection topology 416 may be associated with a second set of characteristics that is different than the first set of characteristics. For example, the simple reprojection process of the simple reprojection topology 416 may not include the composition of RGB layers, or may include the composition of just the RG layers and not the B layer. Moreover, 704 may be performed by the reprojection engine 198 in FIG. 1.

At 706, the apparatus may output an indication of the performed second reprojection process for the frame. For example, 706 may be performed by the reprojection fallback system 450 in FIG. 4B, which may, via the simple reprojection topology 416, output the reprojected Frame N1 and Frame N2 to the frame buffer 418. Moreover, the frame buffer 418 may output the Frame N1_{S} and the Frame N2_{S} to the display 420. Moreover, 706 may be performed by the reprojection engine 198 in FIG. 1.

At 708, the apparatus may output an indication of the performed second reprojection process for the frame by outputting, to a frame buffer, the indication of the performed second reprojection process for the frame. For example, 708 may be performed by the reprojection fallback system 450 in FIG. 4B, which may output, to the frame buffer 418, the Frame N1 generated by the simple reprojection topology 416. Moreover, 708 may be performed by the reprojection engine 198 in FIG. 1.

At 710, the apparatus may output an indication of the performed second reprojection process for the frame by transmitting the indication of the performed second reprojection process for the frame. For example, 710 may be performed by the reprojection fallback system 450 in FIG. 4B, which may transmit Frame N1_{S} to the display 420. Moreover, 710 may be performed by the reprojection engine 198 in FIG. 1.

At 712, the apparatus may output an indication of the performed second reprojection process for the frame by storing, on a memory, the indication of the performed second reprojection process for the frame. For example, 712 may be performed by the reprojection fallback system 450 in FIG. 4B, which may store, on the frame buffer 418, the Frame N1 generated by the simple reprojection topology 416. Moreover, 712 may be performed by the reprojection engine 198 in FIG. 1.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for determining that a first reprojection process for a frame will not complete within a time period. The first reprojection process may be associated with a first set of characteristics. The apparatus may further include means for performing, based on the determination, a second reprojection process for the frame. The second reprojection process may be associated with a second set of characteristics that is different than the first set of characteristics. The apparatus may further include means for outputting an indication of the performed second reprojection process for the frame. The first set of characteristics may include a first composition process. The second set of characteristics may not include the first composition process. The second set of characteristics may include a second composition process different from the first composition process. The first composition process may include a first composition of a set of layers. The second composition process may include a second composition of a subset of the set of layers. The subset of the set of layers may have less layers than the set of layers. The first set of characteristics may include a frame rate. The first set of characteristics may include a resolution. The first set of characteristics may include a composition of layers. The second set of characteristics may include a second frame rate lower than the frame rate layers. The second set of characteristics may include a second resolution lower than the resolution layers. The second set of characteristics may include a second composition of layers having a second number of layers less than a first number of layers of the composition of layers. The first set of characteristics may include a composition of layers. The second set of characteristics may not include any composition of layers. The apparatus may further include means for performing the first reprojection process for a second frame before performing the second reprojection process for the frame. The second set of characteristics may include at least one of a planar-warp or a time-warp of the frame. The apparatus may further include means for outputting a second indication of the performed first reprojection process for the second frame. The apparatus may further include means for performing the first reprojection process for a third frame. The apparatus may further include means for outputting a third indication of the performed first reprojection process for the third frame after outputting the indication of the performed second reprojection process for the frame. The apparatus may further include means for performing the first reprojection process for the third frame by performing the first reprojection process for the third frame before completing the performance of the second reprojection process for the frame. The apparatus may further include means for performing the first reprojection process by reprojecting the second frame based on the first set of characteristics using a first set of hardware. The apparatus may further include means for performing the second reprojection process by reprojecting the frame based on the second set of characteristics using a second set of hardware different from the first set of hardware. The apparatus may further include means for outputting the indication of the performed second reprojection process for the frame by outputting, to a frame buffer, the indication of the performed second reprojection process for the frame. The apparatus may further include means for outputting the indication of the performed second reprojection process for the frame by transmitting the indication of the performed second reprojection process for the frame. The apparatus may further include means for outputting the indication of the performed second reprojection process for the frame by storing, on a memory, the indication of the performed second reprojection process for the frame. The apparatus may further include means for performing the second reprojection process for the frame by performing the second reprojection process for the frame on a GPU.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of graphics processing, comprising: determining that a first reprojection process for a frame will not complete within a time period, wherein the first reprojection process (e.g., using a complex reprojection topology) is associated with a first set of characteristics; performing, based on the determination, a second reprojection process for the frame, wherein the second reprojection process (e.g., using a simple reprojection topology) is associated with a second set of characteristics that is different than the first set of characteristics; and outputting an indication of the performed second reprojection process for the frame.

Aspect 2 is the method of aspect 1, wherein the first set of characteristics comprises a first composition process, wherein the second set of characteristics does not include the first composition process.

Aspect 3 is the method of aspect 2, wherein the second set of characteristics comprises a second composition process different from the first composition process.

Aspect 4 is the method of aspect 3, wherein the first composition process comprises a first composition of a set of layers, wherein the second composition process comprises a second composition of a subset of the set of layers, wherein the subset of the set of layers has less layers than the set of layers.

Aspect 5 is the method of any of aspects 1 to 4, wherein the first set of characteristics comprises at least one of: a frame rate; a resolution; a composition of layers; or a number of points in a sparse warp grid.

Aspect 6 is the method of aspect 5, wherein the second set of characteristics comprises at least one of: a second frame rate (e.g., 90 FPS) lower than the frame rate (e.g., 360 FPS); a second resolution (e.g., 1K) lower than the resolution (e.g., 4K); a second composition of layers having a second number of layers (e.g., 10) less than a first number of layers of the composition of layers (e.g., 30); or a second number of points in a second sparse warp grid (e.g., 100) less than a first number of points in a sparse warp grid (e.g., 1,600).

Aspect 7 is the method of any of aspects 1 to 6, wherein the first set of characteristics comprises a composition of layers, wherein the second set of characteristics does not comprise any composition of layers.

Aspect 8 is the method of any of aspects 1 to 7, further comprising: performing the first reprojection process for a second frame before performing the second reprojection process for the frame, wherein the second set of characteristics comprises at least one of a planar-warp or a time-warp of the frame; and outputting a second indication of the performed first reprojection process for the second frame.

Aspect 9 is the method of aspect 8, further comprising: performing the first reprojection process for a third frame; and outputting a third indication of the performed first reprojection process for the third frame after outputting the indication of the performed second reprojection process for the frame.

Aspect 10 is the method of aspect 9, wherein performing the first reprojection process for the third frame comprises: performing the first reprojection process for the third frame before completing the performance of the second reprojection process for the frame.

Aspect 11 is the method of any of aspects 8 to 10, wherein performing the first reprojection process comprises reprojecting the second frame based on the first set of characteristics using a first set of hardware, wherein performing the second reprojection process comprises reprojecting the frame based on the second set of characteristics using a second set of hardware different from the first set of hardware.

Aspect 12 is the method of any of aspects 1 to 11, wherein outputting the indication of the performed second reprojection process for the frame comprises at least one of: outputting, to a frame buffer, the indication of the performed second reprojection process for the frame; transmitting the indication of the performed second reprojection process for the frame; or storing, on a memory, the indication of the performed second reprojection process for the frame.

Aspect 13 is the method of any of aspects 1 to 12, wherein performing the second reprojection process for the frame comprises: performing the second reprojection process for the frame on a graphics processing unit (GPU).

Aspect 14 is an apparatus for graphics processing including a processor coupled to a memory and, individually or in any combination, configured to implement a method as in any of aspects 1-13.

Aspect 15 is the method of any of aspect 14, wherein the apparatus is a wireless communication device, further comprising a transceiver or an antenna coupled to the processor.

Aspect 16 is an apparatus for graphics processing including means for implementing a method as in any of aspects 1-13.

Aspect 17 is a computer-readable medium (e.g., a non-transitory computer-readable medium) storing computer executable code (e.g., code for graphics processing), the code when executed by at least one processor causes the at least one processor to, individually or in any combination, implement a method as in any of aspects 1-13.

Various aspects have been described herein. These and other aspects are within the scope of the following claims.

What is claimed is:

1. An apparatus for graphics processing, comprising:
a memory; and
a processor coupled to the memory and, based at least in part on information stored in the memory, the processor is configured to:
determine that a first reprojection process for a frame will not complete within a time period, wherein the first reprojection process is associated with a first set of characteristics;
perform, based on the determination, a second reprojection process for the frame, wherein the second reprojection process is associated with a second set of characteristics that is different than the first set of characteristics; and
output an indication of the performed second reprojection process for the frame.

2. The apparatus of claim 1, wherein the first set of characteristics comprises a first composition process, wherein the second set of characteristics does not include the first composition process.

3. The apparatus of claim 2, wherein the second set of characteristics comprises a second composition process different from the first composition process.

4. The apparatus of claim 3, wherein the first composition process comprises a first composition of a set of layers, wherein the second composition process comprises a second composition of a subset of the set of layers, wherein the subset of the set of layers has less layers than the set of layers.

5. The apparatus of claim 1, wherein the first set of characteristics comprises at least one of:
a frame rate;
a resolution;
a composition of layers; or
a number of points in a sparse warp grid.

6. The apparatus of claim 5, wherein the second set of characteristics comprises at least one of:
a second frame rate lower than the frame rate;
a second resolution lower than the resolution;
a second composition of layers having a second number of layers less than a first number of layers of the composition of layers; or
a second number of points in a second sparse warp grid less than a first number of points in a sparse warp grid.

7. The apparatus of claim 1, wherein the first set of characteristics comprises a composition of layers, wherein the second set of characteristics does not comprise any composition of layers.

8. The apparatus of claim 1, wherein the processor is further configured to:
perform the first reprojection process for a second frame before the performance of the second reprojection process for the frame, wherein the second set of characteristics comprises at least one of a planar-warp or a time-warp of the frame; and
output a second indication of the performed first reprojection process for the second frame.

9. The apparatus of claim 8, wherein the processor is further configured to:
perform the first reprojection process for a third frame; and
output a third indication of the performed first reprojection process for the third frame after the output of the indication of the performed second reprojection process for the frame.

10. The apparatus of claim 9, wherein, to perform the first reprojection process for the third frame, the processor is configured to:
perform the first reprojection process for the third frame before completing the performance of the second reprojection process for the frame.

11. The apparatus of claim 8,
wherein, to perform the first reprojection process, the processor is configured to reproject the second frame based on the first set of characteristics using a first set of hardware,
wherein, to perform the second reprojection process, the processor is configured to reproject the frame based on the second set of characteristics using a second set of hardware different from the first set of hardware.

12. The apparatus of claim 1, wherein, to output the indication of the performed second reprojection process for the frame, the processor is configured to:
output, to a frame buffer, the indication of the performed second reprojection process for the frame;
transmit the indication of the performed second reprojection process for the frame; or
store, in the memory, the indication of the performed second reprojection process for the frame.

13. The apparatus of claim 1, wherein the processor comprises a graphics processing unit (GPU).

14. A method of graphics processing, comprising:
determining that a first reprojection process for a frame will not complete within a time period, wherein the first reprojection process is associated with a first set of characteristics;
performing, based on the determination, a second reprojection process for the frame, wherein the second reprojection process is associated with a second set of characteristics that is different than the first set of characteristics; and
outputting an indication of the performed second reprojection process for the frame.

15. The method of claim 14,
wherein the first set of characteristics comprises a first composition process,
wherein the second set of characteristics does not include the first composition process, and
wherein the second set of characteristics comprises a second composition process different from the first composition process.

16. The method of claim 14, wherein the first set of characteristics comprises a composition of layers, wherein the second set of characteristics does not comprise any composition of layers.

17. The method of claim 14, further comprising:
performing the first reprojection process for a second frame before performing the second reprojection process for the frame, wherein the second set of characteristics comprises at least one of a planar-warp or a time-warp of the frame; and
outputting a second indication of the performed first reprojection process for the second frame.

18. The method of claim 17, further comprising:
performing the first reprojection process for a third frame before completing the performance of the second reprojection process for the frame; and
outputting a third indication of the performed first reprojection process for the third frame after outputting the indication of the performed second reprojection process for the frame.

19. The method of claim 17,
wherein performing the first reprojection process comprises reprojecting the second frame based on the first set of characteristics using a first set of hardware,
wherein performing the second reprojection process comprises reprojecting the frame based on the second set of characteristics using a second set of hardware different from the first set of hardware.

20. A computer-readable medium storing computer executable code, the code when executed by a processor causes the processor to:
determine that a first reprojection process for a frame will not complete within a time period, wherein the first reprojection process is associated with a first set of characteristics;
perform, based on the determination, a second reprojection process for the frame, wherein the second reprojection process is associated with a second set of characteristics that is different than the first set of characteristics; and
output an indication of the performed second reprojection process for the frame.
